(19) United States
(12) Patent Application Publication
(10) Pub. No.: US 2007/0130379 A1
(43) Pub. Date: Jun. 7, 2007

(54) Method for data processing based on an operation route in peripheral equipment

(76) Inventor: Ping Ma, ShenZhen (CN)

Correspondence Address: ADVANTIA LAW GROUP, 9035 SOUTH 1300 EAST, SUITE 200, SANDY, UT, 84094, US

(21) Appl. No.: 11/271,117

(22) Filed: Nov. 9, 2005

(51) Int. Cl. G06F 3/00

(52) U.S. Cl. 710/15

(57) ABSTRACT

An improved data processing method for computer resource sharing based on computer peripheral equipment is provided. The peripheral equipment includes a data storage area, and a file storage area where executable program files may be stored. When a computer detects such PLUG-and-PLAY peripheral equipment, the computer realizes execution of executable program files stored in the peripheral equipment by reading the peripheral executable program files and creating corresponding system files in the computer,

### BACKGROUND

1. Field of the Invention

The present invention relates to data processing in computer peripheral equipment. More particularly, the present invention relates to a method for data processing that is based on an operation route in peripheral equipment.

2. Related Art

Data processing in a computer runs under the control of the computer operating system, usually Microsoft Windows or UNIX. Manipulation of a file requires specific processing software that is compatible with the attributes or format of the file. Examples of such software programs include but are not limited to Microsoft Office, AutoCAD, Photoshop and Cordraw. In order to process a variety of types of data, various software programs need to be installed on a computer for identification and manipulation of computer files.

At present, with expanded use of computers, a large number of application software program have been developed. Data produced or processed by one software program usually is not recognizable by other software. Whenever a new type of data is to be processed by a computer, software compatible with the program must be installed on the computer. Since software programs consume a large amount of system resources, excessive installation of software slows down the running and processing of a computer and may eventually cause system failure and data loss. To accommodate a large number of software programs, advanced computers are needed. However, computers with higher processing powers, such as 256 MB EMS memory and 2.0 GHz CPU, incur a higher cost, and may be inaccessible to the a majority of users. Moreover, the running speed of a computer decreases with an increasing number of software programs installed. Thus, even a computer with higher processing power may eventually lose its processing speed and fail to provide satisfactory performance. The present invention provides fast and simple methods that utilize peripheral equipment for data storage and processing, and thus the resources of the main computer system are saved. Therefore, the present invention overcomes the drawbacks of excessive installation of software program on computers.

### SUMMARY OF THE INVENTION

It has been recognized that it would be advantageous to develop a data processing method that does not occupy available computer system resource. This method is based on operation routes in computer peripheral equipment, which provides fast and convenient data processing.

The invention provides a data processing method based on operation routes in peripheral equipment. In this method, a data processing route is set up in the computer peripheral equipment. Through monitoring the formats of files stored in the peripheral equipment, the operating system of a computer captures basic system formation such as file registers from the peripheral equipment. This method provides fast data processing and does not occupy computer system resources.

The present invention provides a data processing method based on operation routes in peripheral equipment. This method requires use of less computer system resources, is cost effective, easy to implement, and is especially suitable for use of moveable storage units with computers.

The present invention is realized as follows:

A method for data processing is based on operation routes in computer peripheral equipment. The computer peripheral equipment includes a data storage area, and a file storage area in which executable program files may be stored. The processing steps of the method include:

Step 1. the computer checks whether or not the peripheral equipment is connected, and whether or not executable program files are stored in the peripheral equipment. If no executable program files are detected, the computer checks for other files in the peripheral equipment. If there are executable program files, then goes to step 2.

Step 2. After the executable program files are detected, these files are then created in the computer system.

Step 3. The computer sets its operation route through the peripheral equipment.

The present invention thus realizes data processing by running the executable program files stored in the computer peripheral equipment. A computer can build various system files as needed for peripheral executable programs such as Office, AutoCAD, Photoshop, Cordraw and Adobe Reader. If a software program is directly installed on a computer, the CPU must read the hard disk before the computer starts up the system software. Thus, running a software program on a computer includes scanning of the hard disk, processing by the CPU and moving up to the computer back bridge. Due to these multiple steps, the running speed of a software program installed in a computer is relatively slow. For example, it may take at least 10 seconds for an AutoCAD program to open a file entirely. However, by the present invention, data is directly outputed to the computer back bridge by the CPU, without access to the hard disk, and so reliability and running speed are much better.

In the present invention, the peripheral equipment is usually PLUG and PLAY. The peripheral equipment has a system storage area in which the system software or the executable programs are stored. System software or executable programs are divided into two parts: one is the operation route and the other is the driver, register and interlinkage files.These two parts of the files need to be stored separately. The head of the files may bear specific file identifiers. After the files of the executable program are checked by the computer, the register, interlinkage files and driver are created under the index of the computer operating system for program running and data processing. In the meantime, the operation route of the computer system points to the peripheral equipment for access to the database of the executable program.

The capacity of current moveable storage system usually have 2-8 GBs or more, which is sufficient for storing and running of executable programs. Moreover, the running of executable programs in the peripheral depends solely on data access and processing by the CPU and does not pass through or occupy any hard disk resources. The running speed of the current moveable storage system can reach 27 MB/Sec, which is much higher than the processing speed of a usual HD. Thus, the present invention provides faster data processing.

The data processing method of the present invention does not run through hard disk, and hence avoids the risk of data loss caused by hard disk breakdown. More importantly, the present invention prevents excessive installation of complex software on a computer, and thus frees hard disk space, and maintains the optimal performance of the computer system.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

The method for data processing based on operation route in peripheral equipment is further described with reference to the accompanying drawings in which:

FIG. 1 is a sketch map representing the hardware structure of the present invention that may be implemented.

FIG. 2 is a flow chart representing the soft ware control of the present invention that may be implemented.

FIG. 3 is a control flow chart representing the executable program system files of the present invention that may be established.

FIG. 4 is another control flow chart representing the operating system files of the present invention that may be established.

FIG. 5 is a capture flow chart representing the supervision of peripheral equipment files that may be implemented.

FIG. 6 is a control flow chart representing the supervision of peripheral equipment that may be implemented.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

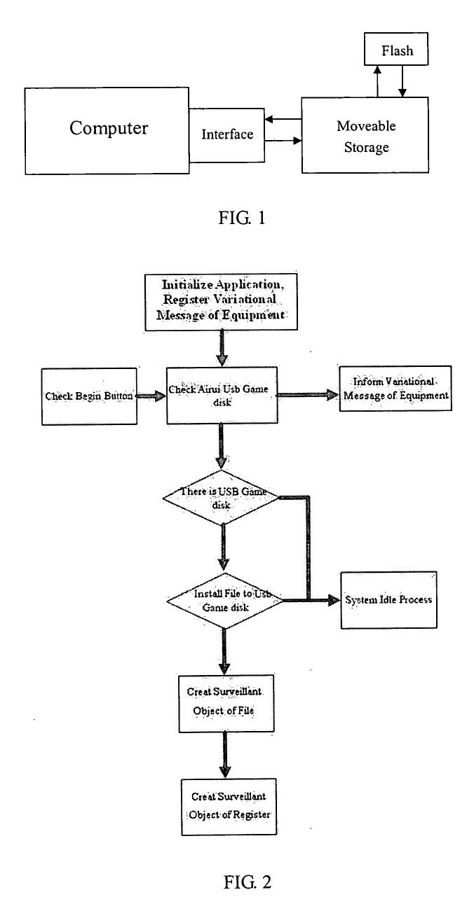

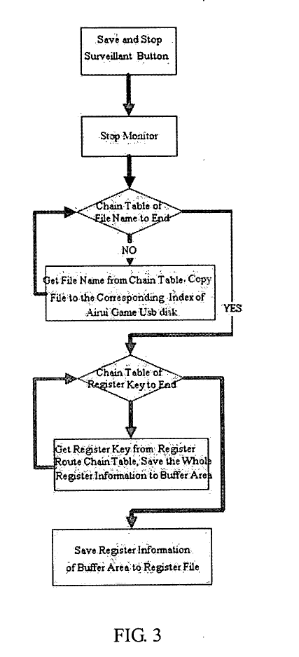

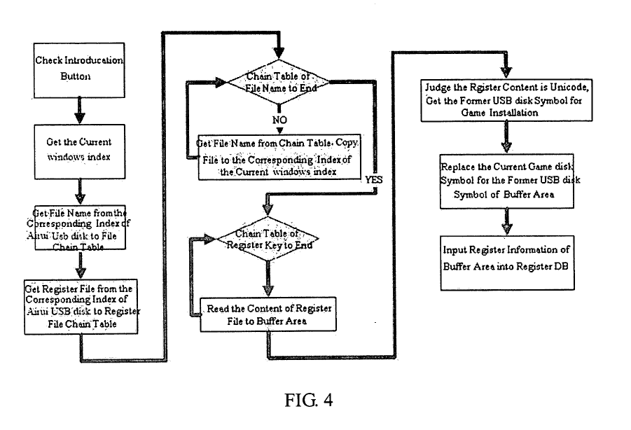

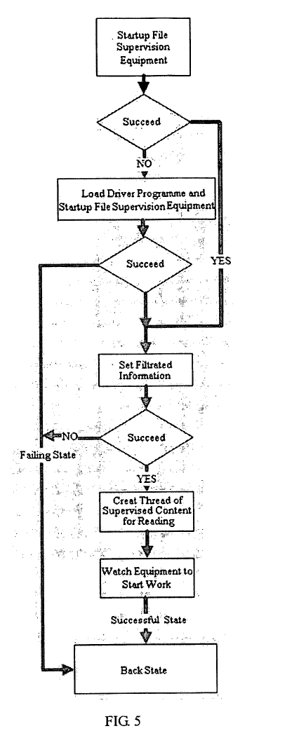

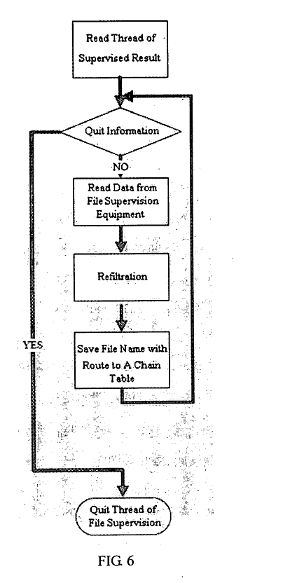

The detailed implementation of the present invention is described below with reference to FIG. 1, FIG. 2, FIG.3, FIG.4, FIG.5 and FIG.6.

As shown in FIG. 1, the present invention is based on hardware which includes a computer and a peripheral storage. In this example, the peripheral storage system is a 2 GB moveable storage system in connection with a computer through a computer interface, which is a universal serial bus (USB), or IEEE 1394 interface. Such computer interface may also include but is not limited to a serial interface, a parallel interface, and a network.

For faster data processing, flash may be integrated in the moveable storage.

The capacity of moveable storage system is commonly at 2-8G or more. The above-mentioned moveable storage system may be a moveable HD, a U disk, MP3, MP4 or other moveable storage system with an effective capacity.

The computer may be any computer, such as a personal computer, as long as the computer recognizes computer interfaces such as USB and 1394.

To realize the present invention, no extra hardware is needed as long as the computer is able to recognize a computer interface such as USB and peripheral equipment that is connected to the computer. However, specific software programs, such as equipment index and command buttons, which are designed to detect and recognize peripheral equipment, need to be installed on the computer. In the peripheral equipment that is connected to the computer through a computer interface, specific areas for storage of executable programs, and generic files and data are separately allocated. Furthermore, system files in the executable program storage area are divided into two parts, one containing basic database and route files, and the other containing register, interlinkage and driver files. Register, interlinkage and driver files may be compressed and packed as needed.

One preferred embodiment of the present invention is shown in FIG. 2 and FIG. 3. FIG. 2 shows an example of how a computer detects whether a game disk, Airui USB Game Disk in this case, is connected to the computer, and how surveillant objects are created for files and register.

As shown in FIG. 2, when a computer is started, it first starts its initialization process, and automatically detects changes of registered equipment. That is, the computer detects whether peripheral equipment is connected to the computer and provides cues or prompts if such equipment is detected. Current computers can detect connections of peripheral equipment in real time and this is the basis of application of computer peripheral equipment.

If new peripheral equipment is detected, the computer determines whether or not there are executable program files stored in the peripheral equipment; if YES, then the executable programs are installed to the computer.

Three modes of detecting executable program files in peripheral equipment are described as follows.

In one mode of detecting executable programs in peripheral equipment, specific identifiers commonly known in the art are set up for the programs.

In another mode of detecting executable programs in peripheral equipment, an identifier is designated for a specific hardware, i.e. peripheral equipment, are the identifier can be recognized by a computer. One type of identifier corresponds to a specific type of executable program. That is, a computer knows the type of executable programs after it determines the type of the peripheral equipment.

In yet another mode of detecting an executable program in peripheral equipment, a computer monitors whether or not peripheral equipment is connected in real time. When peripheral equipment is detected, the computer sends out instructions to the peripheral equipment and the peripheral equipment responds to the instructions. If the responses from the peripheral equipment are confirmed by the computer, register, interlinkage and driver files of the executable program are copied to the computer operating system.

In this mode of detection, an index of the identifiers designated for peripheral executable programs or peripheral equipments are stored in the computer. If a response from peripheral equipment matches one of the identifiers from the index, the response is confirmed.

The identifiers described above may be either placed at the Head or End of the register, interlinkage or driver files, or placed at the Head or the End of the compressed package of these files. The format of the identifiers may be user-defined or defined based on the types of the files.

After detection of peripheral executable programs, the computer records the current state of the computer, i.e. the current operation system index, prior to installation of the peripheral executable programs. The advantage of this step is that, when the job in the peripheral equipment is finished, the computer can return to its prior state by deleting the register, interlinkage and driver files installed under the computer operating system, as shown in the beginning of the flowchart in FIG. 3.

To monitor running of peripheral executable programs and data processing, surveillant objects of files and registers are created in the computer. This can be realized by using existing computer programs, or by designing specific surveillant and control software.

As shown in FIG. 3, when peripheral executable programs are detected, the computer saves the current state, stops the supervision button, and stops running of the computer monitor.

Then the computer queries register information, uncompresses packed files in the peripheral equipment, reads in the register, interlinkage and driver files, and checks whether it reaches the end of the chain table of file names (i.e. whether the table is completely read). If end of the chain table is not reached, the computer gets the remainder file names from the chain table and copies the files to the corresponding index in the peripheral equipment.

After the chain table of file names is completely read, the computer gets the register chain from the route table of the peripheral equipment register, then saves the whole register information to the buffer area of the computer memory, and replaces the previous peripheral identifier with the identifier of current peripheral equipment connected to the computer.

Finally, the computer saves the register information in the buffer area into the register of the computer operating system. At this point, the computer finishes registering of the peripheral equipment, and executable programs can process data in the peripheral equipment.

The above is a detailed description of how the computer registers the peripheral equipment. In order to run the peripheral executable programs, peripheral interlinkage and driver files also need to be created under the computer operating system. Therefore, at the same time the computer reads in and saves register information, interlinkage and driver files from peripheral equipment are packed and transmitted to the computer together with the register information. However, the database of the executable programs still resides in the peripheral equipment. The computer reads it directly from the peripheral equipment, and thus hard disk resource space is not occupied.

In this embodiment, CPU outputs data to the computer back bridge directly, and does not pass through or occupy any hard disk resources. The speed of data processing depends on the running speed of the peripheral equipment. The running speed of current moveable storage systems can reach 27 MB/Sec, which is much higher than the processing speed of a regular hard disk. Thus, the present invention provides faster data processing.

Another embodiment of the present invention is shown in FIG. 4. This embodiment is exemplified using an AutoCAD executable program stored in a moveable storage system. In this example, the computer operating system is Microsoft Windows. A supervising and control software is installed on the computer for real time supervision of the AutoCAD executable program in a movable storage system. The supervising and control software scans the head of the compressed package of register, interlinkage and driver files in the moveable storage system, and determines whether the identifiers captured by scanning matches the executable program index stored in the supervising and control software. When the computer detects the peripheral equipment, the supervising and control software starts up the guide button, and records the current Windows state for future restoration.

Next, the computer gets the file names under the AutoCAD index in the moveable storage system to the file chain table (getting the linkage files);

Next, the computer gets the register files under the AutoCAD index in the moveable storage to the register file chain table (getting the register information);

Next, the computer examines whether it reaches the end of the chain table of file names. If the end of the chain table is not reached, the computer obtains the file from the chain table and copies it to the current Windows index;

Next, the computer examines whether it reaches the end of the register chain table. If the end of the chain table is not reached, the computer reads the register file into the buffer area of the computer memory;

Next, the computer determines whether the content of the register is in Unicode, and obtains the disk identifier for the previous moveable storage system that was connected to the USB.

Next, the computer replaces the previous disk identifier with the disk identifier for the moveable storage currently connected, and gets the file route to point to the current moveable storage system.

Next, the computer transfers the register information in the buffer area to the register database, which enables the executable program AutoCAD to be registered in the computer operating system, Windows in this case. However, the database of AutoCAD programs, which are addressable at any time, still resides in the moveable storage, not in the computer hard disk. When AutoCAD is running, the CPU reads data directly from the current data route, i.e. the moveable storage system, not from the computer hard disk.

The driver files and the chain table of file names are also transferred into the computer and created under the index of Windows.

After the moveable storage system is removed from the computer, whether or not the executable program is still running, or whether or not the data in the moveable storage system is still being processed, the computer deletes all files related to the peripheral executable programs, and restores the initial state prior to the connection of the moveable storage system. Therefore, the system resources on hard disk are not abused, and the hard disk can maintain optimal performance.

The connection of peripheral equipment to a computer is captured by supervising and control software or equipment installed on the computer. FIG. 5 and FIG. 6 are flowcharts that depict the supervising process of a computer over connection of any peripheral equipment. The computer is equipped with supervising software or equipment, File Supervision Equipment as in FIG. 5 and FIG. 6. The File Supervision Equipment starts to run with the startup of the computer. The File Supervision Equipment scans every interface of the computer, usually one scan per computer clock, and compares the current state with the previous state. If there are any changes, the computer sends out instructions, obtains the corresponding peripheral equipment information, and reads in its data according to the steps as described in the above embodiments of the present invention.

The preferred embodiments and figures are described above to best illustrate the function, components, steps, and controls of the present invention. The present invention is not limited to the embodiments described, but many variations and modifications are within the scope of the claims of the invention. The components, controls and steps can be implemented in other settings, for example in distributed systems over a network or in a system including multiple peripheral equipment.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

I claim:

1. A method for data processing based on operation routes in computer peripheral equipment, which contains a data storage area and a file storage area in which executable program files may be stored, comprising:
a series of detection steps including: first, a computer detects whether or not a peripheral equipment is connected; if the peripheral equipment is not connected, said computer does nothing; if said peripheral equipment is connected, said computer checks whether or not executable program files are stored in said peripheral equipment; if no executable program files are detected, said computer simply displays any files that are stored in said peripheral equipment; if executable program files are detected, said computer goes to the next step;
a creation step wherein said executable program files from said peripheral equipment are created in the computer system; and
a setup step wherein said computer sets its operation route as said peripheral equipment.

2. A method according to claim 1, wherein said operation route is saved independently in said peripheral equipment, and register, interlinkage files and driver files are packed and saved separately from said operation route in said peripheral equipment.

3. A method according to claim 2, wherein said file storage area comprises a system storage area, where two groups of system software are saved separately from each other, wherein one group of system software includes operation routes and the other group of system software includes driver, register and interlinkage files.

4. A method according to claim 2, further comprising a creation step wherein said register, interlinkage files and diver files are created under the operating system index of said computer.

5. A method according to claim 4, further comprising a pointing step wherein said operation route points to said peripheral equipment.

6. A method according to claim 1, further comprising a back-up step wherein the current state of said computer system is backed up, and a restoration step wherein any files related to said peripheral equipment in the computer system are deleted and said state is restored after operation of said peripheral equipment is finished.

7. A method according to claim 1, wherein said peripheral equipment is a moveable storage system, and the capacity of said moveable storage system is more than 2 GB.

8. A method according to claim 7, wherein said moveable storage system includes a moveable hard disk, a U disk, an MP3 and MP4.

9. A method according to claim 1, wherein in said detection step, said computer detects executable program files by recognizing specific file identifiers attached to said program files.

10. A method according to claim 9 wherein said executable program files include register, interlinkage files and driver files, and specific file identifiers are set at the head or the end of said register, interlinkage files and driver files.

11. A method according to claim 9, wherein said executable program files include a compressed package of register, interlinkage files and driver files, and specific file identifiers are set at the head or the end of said compressed package.

12. A method according to claim 5, further comprising a reading step, wherein, after the operation route of said computer points to the register, interlinkage files and driver files in said peripheral equipment, the CPU of said computer reads the register information into the buffer area of the memory of said computer; and a replacing step, wherein, said computer replaces the disk symbol which denotes a peripheral equipment previously connected to said computer with the disk symbol which denotes the peripheral equipment currently connected to said computer.

13. A method according to claim 12, further comprising a judging step which occurs after said reading step but prior to the said replacing step, wherein, said computer determines whether or not said register information is in Unicode.

14. A method according to claim 12, further comprising a transmission step wherein, after said reading and replacing step, said register information in the buffer area of said memory is transmitted into the register database of said computer.
